(19) United States
(12) Patent Application Publication
(10) Pub. No.: US 2021/0023661 A1
(43) Pub. Date: Jan. 28, 2021

(54) METHOD FOR REPAIRING A TITANIUM BLADE TIP

(71) Applicant: PRATT & WHITNEY CANADA CORP., Longueuil (CA)

(72) Inventor: Samuel PANERO, Montréal (CA)

(21) Appl. No.: 16/521,034

(22) Filed: Jul. 24, 2019

(51) Int. Cl. B23P 6/00; F01D 5/00

(52) U.S. Cl. CPC B23P 6/007; B23K 26/342; F01D 5/005

(57) ABSTRACT

Methods of repairing and maintaining rotor blade tips are provided. Filler wire may be positioned at an angle to an electrode and positioned vertically above a blade tip. Filler wire may be deposited from vertically above a blade tip to be repaired. The melting and depositing may occur in an inert environment.

### FIELD

This relates generally to rotor blades, and more particularly to repairing rotor blades.

### BACKGROUND

Operation of aircraft engines such as gas turbine engines involves wear to various engine components. These components may require maintenance or repair in order to ensure performance and reliability. Maintenance or repair of certain components can be costly.

### SUMMARY

According to an aspect, there is provided a method of repairing a titanium blade of a gas turbine engine, the method comprising: providing an inert gas on a tip of the titanium blade; causing a molten pool to form on the tip using an electric current flowing between an electrode and the tip; and introducing a filler material including titanium into the molten pool along a direction that is at an angle less than 50 degrees to an orientation of the electrode.

According to another aspect, there is provided a method of repairing a titanium blade tip of a gas turbine engine, the method comprising: providing a filler material, an electrode, and the titanium blade tip within a sealed enclosure having an inert atmosphere, the filler material being oriented at an angle less than 50 degrees from the electrode; causing an electric current to flow between the electrode and the titanium blade tip; introducing the filler material proximal to an arc formed between the electrode and the titanium blade tip; and depositing a portion of the filler material onto a first section of the titanium blade tip being located vertically below the electrode.

Other features will become apparent from the drawings in conjunction with the following description.

### BRIEF DESCRIPTION OF DRAWINGS

In the figures which illustrate example embodiments,

FIG. 1 is a schematic axial cross-sectional view of a gas turbine engine;

FIG. 2 is a perspective view of a rotor assembly including a plurality of blades;

FIG. 3 is an enlarged view of a blade tip having a build-up of welding material deposited thereon;

FIG. 4 is a diagram depicting a tungsten inert gas (TIG) welding process;

FIG. 5 is a diagram depicting a TOPTIG welding process;

FIG. 6 is a flow chart depicting a process for repairing a blade tip for a gas turbine engine;

FIG. 7 is a flow chart depicting a process for repairing a blade tip for a gas turbine engine;

FIG. 8 is a schematic illustration of an example sealed enclosure in which certain embodiments described herein may be performed.

### DETAILED DESCRIPTION

Aspects of various embodiments are described through reference to the drawings.

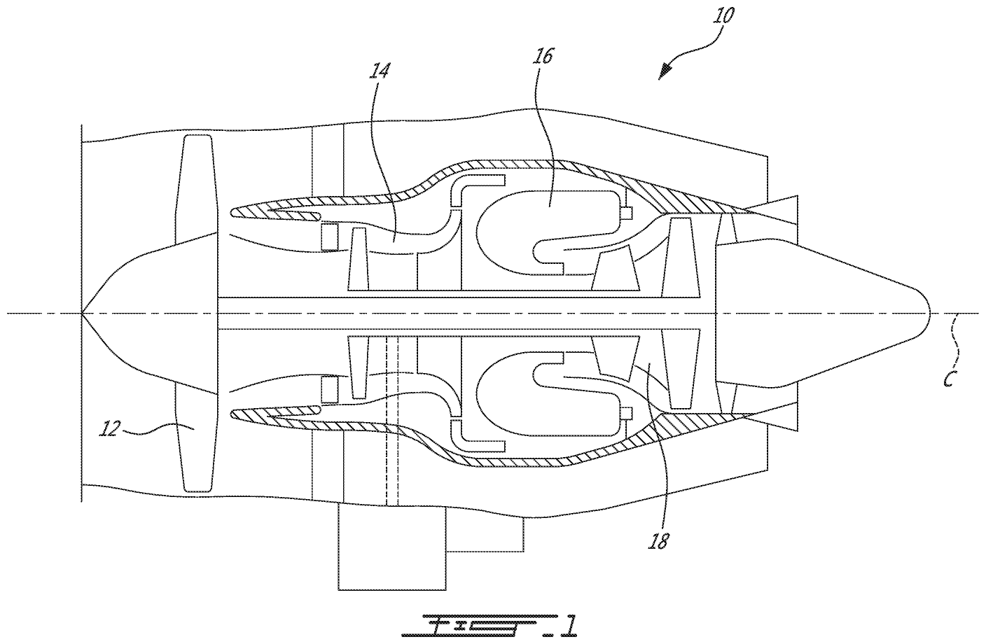

FIG. 1 illustrates a gas turbine engine 10 preferably provided for use in subsonic flight, generally comprising in serial flow communication a fan 12 through which ambient air is propelled, a multistage compressor 14 for pressurizing the air, a combustor 16 in which the compressed air is mixed with fuel and ignited for generating annular stream of hot combustion gases, and a turbine section 18 for extracting energy from the combustion gases. The fan 12, the multistage compressor 14, and the turbine section 18 may be rotatable about a central axis C of the engine 10.

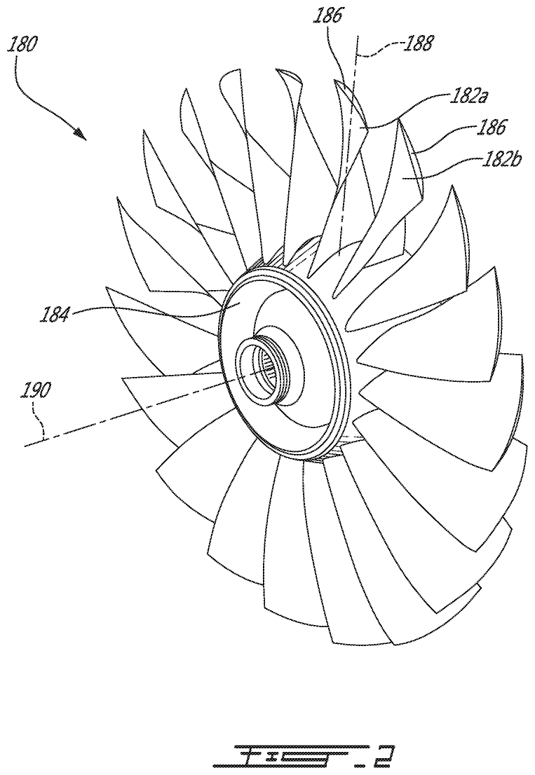

FIG. 2 is a perspective view of a bladed rotor 180 and a plurality of blades 182a, 182b, collectively referred to herein as blades 182. Blades 182 may be mounted to and extend radially outward from hub 184. During use, rotor 180 may be disposed within a gas path inside gas turbine engine 10. Bladed rotor 180 may be fan 12, may be part of compressor section 14 or may be part of turbine section 18 of gas turbine engine 10. For example, blades 182 may be fan blades, compressor blades or turbine blades. Bladed rotor 180 may be exposed to ambient air, compressed air or hot combustion gasses that may interact with blades 182. In some embodiments, blade tips 186 are made of titanium or a titanium alloy. In operation, bladed rotor 180 may rotate about axis 190, parallel to (e.g., and coaxial with) central axis C. Axis 188 may extend radially from axis 190 and may represent a stacking line of blade 182a. A stacking line is a reference line used to designate the position in space of planar cross sections of a blade 182a.

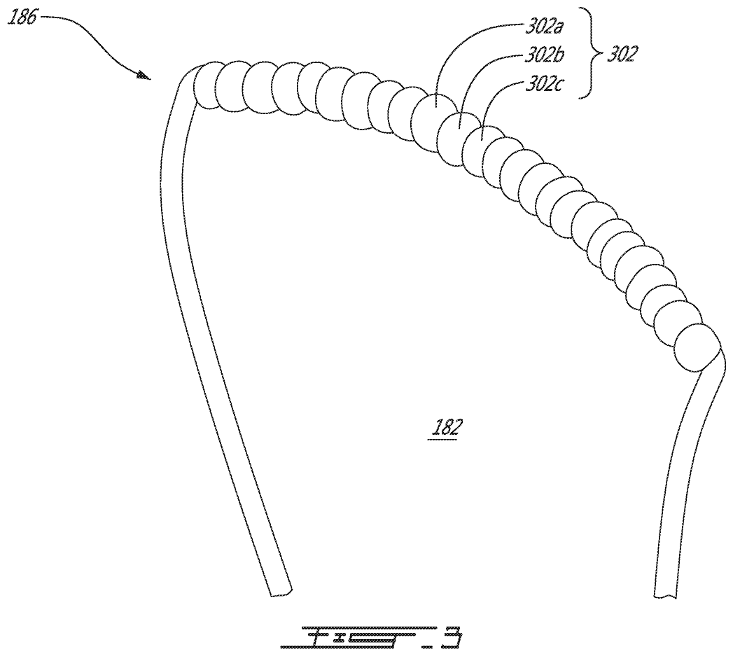

During operation of engine 10, blade tips 186 of blades 182 may experience wear and/or degradation due to friction and exposure to high temperatures. Another source of wear may include the combination of foreign objects and a small gap between blade tips and a fan casing for example. To prolong the operational life of blades 182, the blade tips 186 may be repaired by introducing extra material onto blade tips 186 via a tungsten inert gas (TIG) welding process. In some embodiments, filler material 302 (shown in FIG. 3) may be deposited onto a blade tip 186 to extend the operational lifetime of blade 182. In some embodiments, filler material 302 includes titanium. In some embodiments, a major constituent of filler material 302 may be titanium.

FIG. 3 is an enlarged view of a blade tip 186 having a build-up of welding material deposited thereon. As depicted, blade tip 186 has a number of deposits 302a, 302b, 302c (collectively referred to as deposits 302) disposed thereon. Deposits 302 are made of a filler material which may be melted and deposited onto blade tip 186. In some embodiments, one or more deposits 302 are made of the same material as (or a material that is compatible with) the material from which blade 182 is made. In some embodiments, deposits 302 are made of titanium. In some embodiments, deposits 302 are made of a titanium alloy.

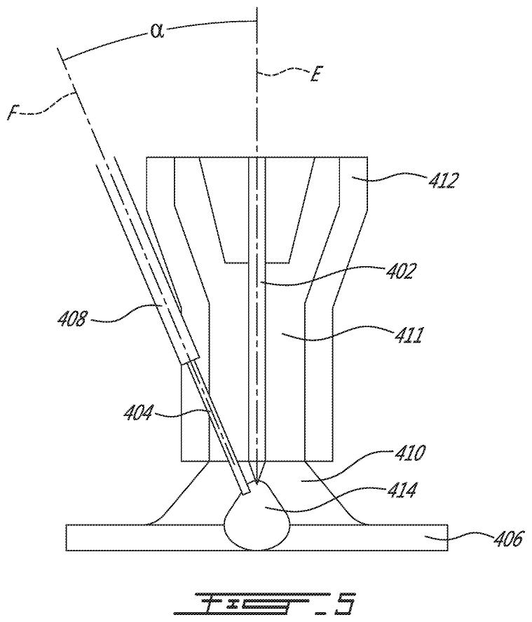

In some embodiments, deposits 302 are deposited on to blade tip 186 using a welding process. In some embodiments, the welding process may be a Tungsten Inert Gas (TIG) welding process. In some embodiments, the welding process may be a so-called “TOPTIG” welding process, as described, for example, in French Patent No. 2,956,053, the entire contents of which are hereby incorporated by reference, and with reference to FIG. 5 of the present disclosure. In some embodiments, the welding process includes melting and depositing filler material on a surface. In some embodiments, a portion of the surface may melt into a molten pool which mixes with the filler material.

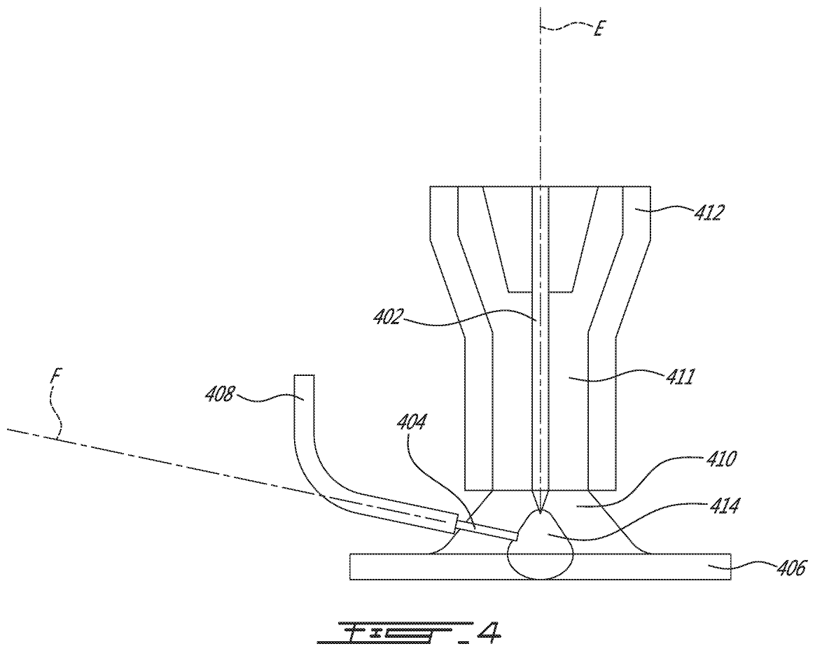

Previous attempts at repairing blade tips 186 involved the use of electron beam welding, which requires the placement of the blade and the filler material into a vacuum chamber, which is time-consuming and expensive. In addition, electron beam welding may require a large vacuum chamber, which is typically available only on more expensive electron beam weld machines. Moreover, a TIG welding process including a wire of filler material 404 oriented at an angle close to 90 degrees to the electrode 402 (see, e.g., angle between axis E and F in FIG. 4). This orientation of the filler material 404 can be problematic and can result in non-uniform welding deposits on the blade tip which do not adequately follow the shape of the blade tip 186.

Contrastingly, some embodiments herein allow for the filler material wire 404 to be in a near-vertical orientation which may, in some situations, provide better control over the welding process and facilitate more uniform weld deposits 302 which better follow the shapes of blade tips 186 relative to other welding techniques. In reference to FIG. 5, angle α between axis E of filler wire 404 (or of wire guide 408) and axis F of electrode 402 of the TIG welding device. The welding device of FIG. 5 may be part of a robotic arc welding system. In some embodiments, angle α may be less than 50 degrees. In some embodiments, angle α may be less than 30 degrees. In some embodiments, angle α may be less than 20 degrees. In some embodiments, the angle α may be between 5 and 50 degrees. In some embodiments, the angle α may be between 10 and 30 degrees. In various embodiments, the angle α may be about 5 degrees, 10 degrees, 15 degrees, 20 degrees, 25 degrees, 30 degrees, 35 degrees, 40 degrees or 45 degrees.

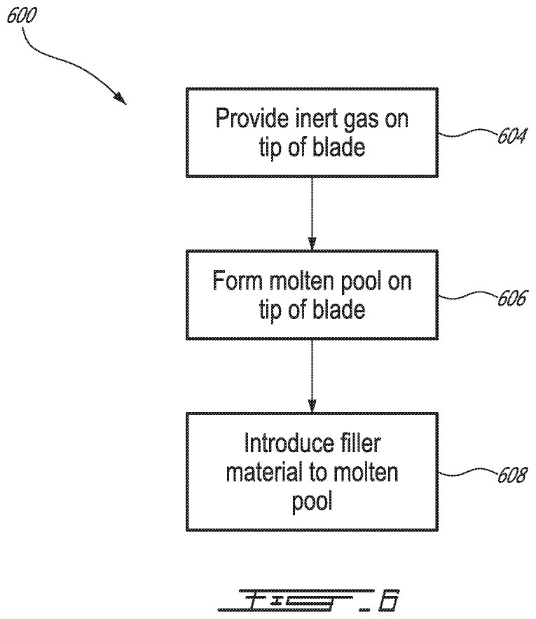

FIG. 6 is a flow chart depicting an example process 600 for repairing a titanium blade tip for a gas turbine engine. Process 600 may be conducted using a TOPTIG welding device as illustrated in FIG. 5 for example. It is understood that aspects of method 600 may be combined with aspects of other methods described herein. Filler material 404 (e.g., in wire form) may be oriented in a substantially vertical position above a blade tip. The term “substantially” as used herein may be applied to modify any quantitative representation which could permissibly vary without resulting in a change in the basic function to which it is related. In some embodiments, orienting filler material 404 in a vertical position may include passing a wire made of filler material 404 through a wire guide 408 to ensure a particular angle of orientation and delivery relative to an electrode 402. In some embodiments, filler material 404 is titanium. In some embodiments, the filler material 404 may be commercially pure titanium or may be a titanium alloy. In some embodiments, electrode 402 is made of tungsten. In some embodiments, orienting the filler material 404 vertically and/or relative to the blade tip 186 may include orienting the blade tip 186 rather than moving the filler material 404.

Although some embodiments include orienting a filler wire 404 to reach a specific angle α with electrode 402 and a substantially vertical orientation relative to blade tip 186, it is contemplated that other embodiments may include angles of orientation which diverge from being purely or nearly vertical. For example, in FIG. 5, electrode 402 appears to be vertical while filler wire 404 appears to be in an orientation which is approximately 20 degrees relative to electrode 402. In some embodiments, the angle α between electrode 402 and filler wire 404 is between 5 and 50 degrees. In some embodiments, the angle α between electrode 402 and filler wire 404 is between 10 and 30 degrees. In some embodiments, the angle α between electrode 402 and filler wire 404 is 20 degrees. The angle α may be fixed during use of the welding device of FIG. 5.

Moreover, it is contemplated that electrode 402 can be oriented at an angle which is not vertical, in order for filler wire 404 to be substantially vertically oriented and positioned vertically above the surface 406 of blade tip 186. As such, embodiments are contemplated in which various orientations of filler wire 404 are not vertical.

At 604, an inert gas 410 is provided proximal to blade tip 186. In some embodiments, inert gas 410 is dispensed via a passage 411 defined by nozzle 412 proximal to electrode 402 of the welding device. In some embodiments, the blade tip 186 is in an atmosphere of inert gas 410 without inert gas being dispensed from nozzle 412. In some embodiments, the atmosphere is mainly inert gas and nozzle 412 dispenses further inert gas 410. In some embodiments, inert gas 410 is argon gas. In some embodiments, inert gas 410 may be any non-reactive gas suitable for reducing the likelihood of the reactions with oxygen and other constituents of air.

At 606, an electric current is passed through electrode 402 and surface 406 (i.e., of blade tip 186), resulting in an arc 414 which causes an increase in temperature in the area of arc 414. In some embodiments, the temperature in the area of arc 414 exceeds the melting temperature of the filler material 404 and/or the blade tip 186. In some embodiments, part of blade tip 186 may be melted into a molten pool. Filler material 404 may be placed in the vicinity of arc 414, thereby causing filler material 404 to also melt and drop into the molten pool.

At 608, the melted filler material 404 is deposited onto the section of blade tip 186 in which the molten pool is located. In some embodiments, filler material 404 is deposited vertically downward due to gravity. As such, in some embodiments, electrode 402 and filler material 404 are placed vertically above blade tip 186, such that molten droplets of filler material 404 will fall onto blade tip 186. In some embodiments, the electrode 402 is positioned vertically above blade tip 186. In some embodiments, the filler material 404 is introduced to (or fed toward) the blade tip 186 along a direction that is less than 50 degrees to the orientation of electrode 402 as defined by wire guide 408 for example. In some embodiments, the filler wire 404 is positioned substantially parallel to a stacking line 188 of the blade 182. In some embodiments, electrode 402 is positioned substantially parallel to a stacking line 188 of blade 182.

Once droplets of filler material 404 have been deposited on to blade tip 186 or into a molten pool on blade tip 186, and the arc 414 removed, the molten filler material 404 may cool and solidify. In some embodiments, the filler material 404 may mix with the molten pool already formed by arc 414 on blade tip 186.

In some embodiments, inert gas 410 in the vicinity of the filler material 404 and blade tip 186 allows for the molten filler material 404 to cool and/or mix with molten surface material on blade tip 186 without excessively reacting with various elements normally present in air. For example, an inert environment in the vicinity of the weld may prevent molten filler material 404 from reacting with oxygen (normally present in air), which may allow for a stronger resulting weld after the filler material 404 has cooled. In particular, when the filler material 404 is titanium, it may be beneficial to avoid exposing the titanium to oxygen while it cools, as the presence of titanium oxides in the deposited material 302 may result in a weaker weld.

In some embodiments, process 600 may further include subsequently moving the electrode 402 and filler wire 404 to a different location vertically above blade tip 186. In some embodiments, a second portion of filler material 302b may be introduce to a portion of blade tip 186 which is adjacent to the first portion 302a deposited on to blade tip 186. For example, as depicted in FIG. 3, repairing blade tip 186 may entail introducing multiple deposits 302 of filler material 404 on to blade tip 186 on adjacent portions. In some embodiments, deposits 302a, 302b may overlap. That is, deposit 302b may be in physical contact with deposit 302a. In some embodiments, deposit 302a is allowed to cool prior to effecting introduction of deposit 302b. In some embodiments, deposit 302b may be deposited on blade tip 186 prior to deposit 302a having fully cooled.

In some embodiments, the resulting deposit(s) 302 of filler material 404 on blade tip 186 may be heat treated and/or polished thereafter. Heat treatments may include, for example, precipitation hardening, annealing, stress relief, or the like.

In some embodiments, process 600 is performed in an inert atmosphere.

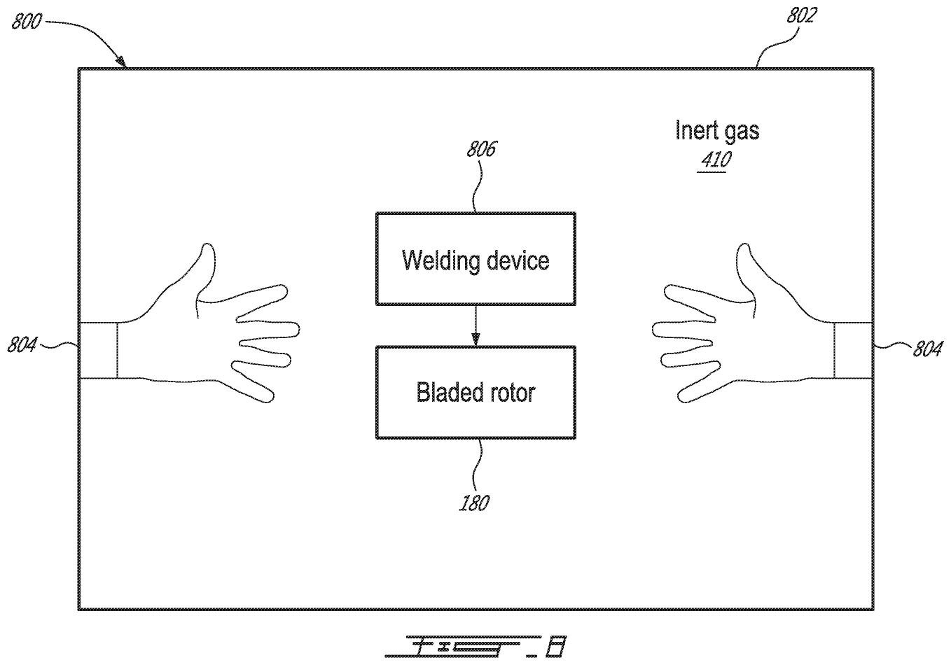

In addition to dispensing inert gas 410 in the immediate vicinity of electrode 402 and filler material 404, it may be advantageous to provide an inert atmosphere in a broader area to prevent oxidation and other undesirable reactions from occurring. In some embodiments, process 600 may be performed within a sealed enclosure, such as the sealed enclosure 800 depicted in FIG. 8.

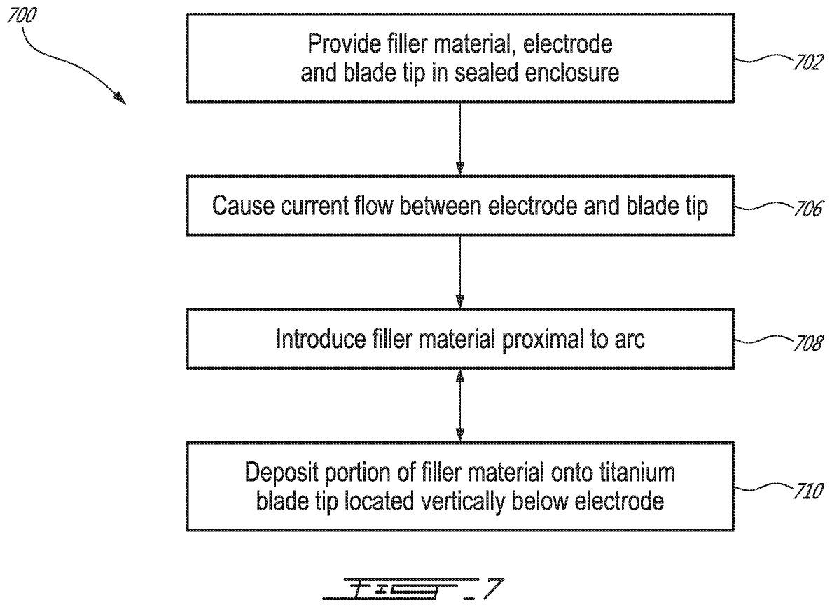

FIG. 7 is a flowchart depicting an example process 700 for repairing a titanium blade tip 186 of a gas turbine engine. Process 700 may be conducted using a TOPTIG welding device as illustrated in FIG. 5 for example. It is understood that aspects of method 700 may be combined with aspects of other methods described herein. At 702, filler material 404, electrode 402 and blade tip 186 are provided in a sealed enclosure having an inert atmosphere. The inert environment may include, for example, inert gas 410 such as argon. In some embodiments, the inert environment may be an environment within a sealed enclosure 800 (e.g., see FIG. 8) which has been purged with an inert gas 410 (e.g. argon gas).

Filler material 404 may be oriented at an angle α to electrode 402. In some embodiments, the angle α is less than 50 degrees. In some embodiments, the angle α is between 5 and 50 degrees. In some embodiments, the angle α is between 10 and 30 degrees. In some embodiments, the angle is about 20 degrees.

At 706, an electric current may be provided to electrode 402, thereby causing a current to flow between electrode 402 and blade tip 186. In some embodiments, the flowing current may cause an arc 414 to form. The arc 414 may raise the temperature in the space between the electrode 402 and the blade tip 186. In some embodiments, the arc 414 may cause a molten pool of blade tip 186 material to form on the surface of blade tip 186.

At 708, filler material 404 may be introduced proximal to the arc 414, thereby causing a portion of the filler material 404 to melt due to the high temperatures caused by the arc 414.

At 710, the melted portion of filler material 404 is deposited on to a first section of blade tip 186. In some embodiments, the tip of filler material 404 is placed in close proximity to electrode 402 and vertically above the first section of blade tip 186, such that the action of gravity causes molten drops of filler material 404 to drip onto a first section of blade tip 186. In some embodiments, the deposited filler material may mix with the molten pool of blade tip 186 material.

In some embodiments, after depositing filler material 404 on the first section of blade tip 186 to form first deposit 302a, filler material 404 and electrode 402 are re-positioned to a second configuration. The second configuration may include at least the filler and/or electrode 402 being in second location still vertically above a portion of blade tip 186. Alternatively, blade tip 186 may be re-positioned to a second location such that a portion of blade tip 186 is located vertically below electrode 402. A second portion of filler material 404 may be melted and deposited on to a second portion of blade tip 186 to form second deposit 302b. In some embodiments, the first and second portions of blade tip 186 are adjacent. In some embodiments, deposits 302a, 302b are in physical contact and the first and second portions of blade tip 186 are sufficiently proximal to one another to cause a degree of overlap between the first and second deposits 302a, 302b.

The above-noted process of depositing portions of filler material 404 on to blade tip 186 may be repeated to deposit a plurality of portions of filler material 404 on to blade tip 186. In some embodiments, the plurality of deposits 302 may form one or more layers covering some or all of blade tip 186. Moreover, the above-noted process may be repeated for multiple different blades 182a, 182b. In this manner, maintenance and repairs for multiple blades 182 may be provided to maintain performance and reliability of rotor 180 in engine 10.

In some embodiments, after the plurality of deposits 302 have been cooled sufficiently and solidified, the plurality of deposits may be heat treated and/or polished. Further treatments, such as sanding and/or shaping (e.g., machining, grinding) of deposits 302 may be carried out to ensure the blade tip 186 is returned to proper dimensions prior to resuming use in gas turbine engine 10.

FIG. 8 is a schematic illustration of an example sealed enclosure 800 which may be used to facilitate performing some embodiments of processes described herein. As depicted, enclosure 800 includes a membrane 802 (made of, e.g., a polymer sheet), and one or more openings 804 adapted to receive, for example, gloves for an outside user to manipulate objects contained within enclosure 800. In the example embodiment shown in FIG. 8, a (e.g., TOPTIG) welding device 806 (or part thereof) and bladed rotor 180 is contained within sealed enclosure 800. In some embodiments, membrane 802 may be made of a rigid material. In embodiments in which membrane 802 is made of a rigid material, enclosure 800 may be vacuumed prior to pumping in inert gas 410. In some embodiments, membrane 802 may be made of a flexible material. Membrane 802 may be transparent or translucent, so as to allow a user to observe actions taking place within enclosure 800.

Enclosure 800 may be substantially air tight. In some embodiments, inert gas 410 may be pumped into sealed enclosure 800 such that the atmosphere within enclosure 800 comprises mainly inert gas. In some embodiments, the inert gas is argon. The presence of an inert gas atmosphere within enclosure 800 may facilitate strong welds because molten filler material 404 can cool down after being deposited onto blade tip 186 without reacting with, e.g., oxygen or other materials normally present in air which may weaken weld strength.

In the embodiment depicted in FIG. 8, membrane 802 is a flexible material. The use of a flexible membrane 802 for enclosure 800 may allow for greater flexibility of use and lower costs. For example, an enclosure 800 with a flexible membrane can be set up in a wider variety of locations, with fewer constraints on open space relative to a rigid framed enclosure, and in less time than would be required by a rigid enclosure. As such, the use of a flexible membrane 802 for enclosure 800 may offer advantages in terms of efficiency and cost relative to processes which require a rigid enclosure and/or a vacuum chamber (such as, e.g., electron beam welding machines).

Of course, the above described embodiments are intended to be illustrative only and in no way limiting. The described embodiments are susceptible to many modifications of form, arrangement of parts, details and order of operation. The invention is intended to encompass all such modification within its scope, as defined by the claims.

What is claimed is:

1. A method of repairing a titanium blade of a gas turbine engine, the method comprising:
providing an inert gas on a tip of the titanium blade;
causing a molten pool to form on the tip using an electric current flowing between an electrode and the tip; and
introducing a filler material including titanium into the molten pool along a direction that is at an angle less than 50 degrees to an orientation of the electrode.

2. The method of claim 1, further comprising enclosing the blade tip and the filler material in a sealed enclosure.

3. The method of claim 2, wherein the sealed enclosure is flexible.

4. The method of claim 2, wherein the sealed enclosure contains an atmosphere of the inert gas.

5. The method of claim 1, wherein the electrode is positioned vertically above the tip.

6. The method of claim 1, wherein the electrode is positioned substantially parallel to a stacking line of the titanium blade.

7. The method of claim 1, further comprising cooling the filler material in an inert environment.

8. The method of claim 7, further comprising heat treating the cooled filler material.

9. The method of claim 1, wherein the inert gas is argon.

10. The method of claim 1, wherein the angle is 20 degrees to the orientation of the electrode.

11. A method of repairing a titanium blade tip of a gas turbine engine, the method comprising:
providing a filler material, an electrode, and the titanium blade tip within a sealed enclosure having an inert atmosphere, the filler material oriented at an angle less than 50 degrees from an orientation of the electrode;
causing an electric current to flow between the electrode and the titanium blade tip;
introducing the filler material proximal to an arc formed between the electrode and the titanium blade tip; and
depositing a portion of the filler material onto a first section of the titanium blade tip being located vertically below the electrode.

12. The method of claim 11, further comprising re-positioning the titanium blade tip or electrode to a second configuration, and depositing a second portion of the filler material onto a second portion of the titanium blade tip, the second portion being located vertically below the electrode.

13. The method of claim 11, wherein the angle is between 5 and 50 degrees.

14. The method of claim 11, wherein the angle is between 10 and 30 degrees.

15. The method of claim 11, wherein the inert atmosphere includes argon gas.

16. The method of claim 11, wherein the electrode is positioned substantially parallel to a stacking line of the titanium blade.

17. The method of claim 11, wherein the electrode is positioned vertically above the titanium blade tip.

18. The method of claim 11, wherein the arc formed between the electrode and the titanium blade tip causes a molten pool to form on the titanium blade tip.

19. The method of claim 18, wherein the first portion of the filler material is disposed in the molten pool formed on the titanium blade tip.

20. The method of claim 11, further comprising removing the arc formed between the electrode and titanium blade tip subsequent to the depositing.
